(19) United States
(12) Patent Application Publication
(10) Pub. No.: US 2008/0127802 A1
(43) Pub. Date: Jun. 5, 2008

(54) Guitarp

(76) Inventor: Harry Eldon Wood, Madisonville, LA (US)

Correspondence Address: HARRY ELDON WOOD, 177 HWY 22E, MADISONVILLE, LA, 70447, US

(21) Appl. No.: 11/895,962

(22) Filed: Aug. 28, 2007

Related U.S. Application Data
(60) Provisional application No. 60/872,594, filed on Dec. 4, 2006.

(51) Int. Cl. G10D 3/00

(52) U.S. Cl. 84/317

(57) ABSTRACT

This is a modified guitar equipped with cord bars and strung chromatically with multiple strings (notes). For each cord desired the notes that do not pertain are dampened by depressing the desired cord bar. The key for the desired song is fixed by a capo. This instrument is idea for people with handicaps such as arthritis, etc, or people with little musical knowledge or experience, since memorized multiple finger arrangements or finger placements are not necessary. Rhythm and Melodies can be played with proper strumming and cord bar usage.

### BACKGROUND AND DISCUSSION OF INVENTION

### Field of Invention

The GUITARP (1) is a musical string instrument. It utilizes some features of the standard guitar, autoharp, and dobro. Because the GUITARP (1) has multiple strings (2) tuned chromatically to different notes in the scale, (the guitar has six), a capo (3) will change keys in lieu of cords as in the standard guitar. Once the key has been fixed by the capo, (an autoharp can not do this), the cords are made by pushing a single cord bar (4). This allows felts (5) which is attached to the cord bar (4) to deaden unwanted notes allowing only desired notes to sound. Cords are made on a standard guitar by pushing several strings against frets so as to change the sound of the strings producing a desired cord.

The nut (6) and bridge (7) are level in lieu of being curved as in a standard guitar. The strings will therefore be level thus allowing cord bars (4) to make proper contact. Melodies can be played using a slide, as is done with a dobro guitar. The body (1) of this instrument is different from an autoharp, therefore it offers a sound that can not be achieved with an autoharp.

The GUITARP (1) allows music to be played without multiple finger movements, which requires agility and memory or repetitive practice. This would be beneficial to people with reduced capabilities due to arthritis, aging, lack of musical training, etc.

### BRIEF DISCUSSION OF DRAWING

In the drawing:

FIG. 1 shows a top view of the operating area of the GUITARP.

FIG. 2 shows a section elevation through the cord bar area.

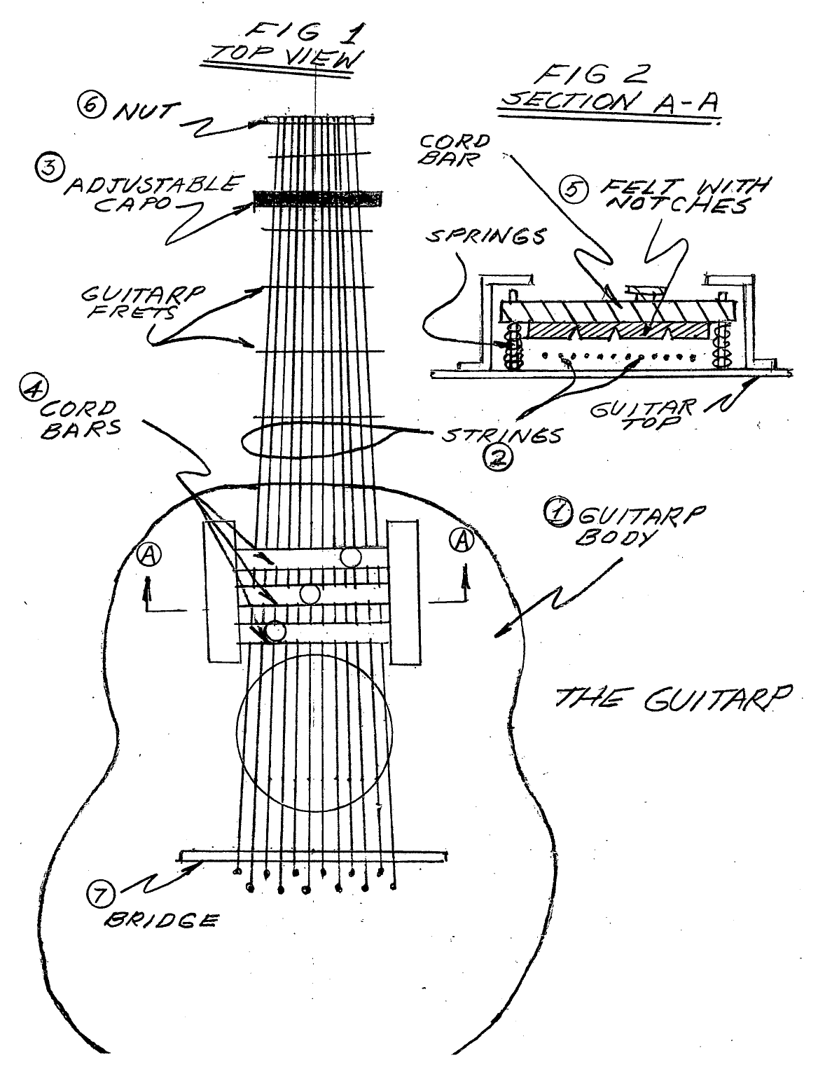

What I claim is:

1. A musical instrument utilizing a modified twelve string guitar consisting of:
1. A multiple number of strings of proper size to allow multiple notes chromatically tuned to a desired open key (in lieu of standard six notes, which is present design and inadequate to cover a complete musical scale)
2. A level nut and bridge (in lieu of standard curved ones) to allow cord bars to make total contact on all strings
3. Spring loaded cord bars equipped with notched felts to allow various desired cord notes to sound while damping the undesired notes. The design and number of the cord bars, their method of assembly, and the method of securing to the instrument can vary and is not limited to that shown in the drawing or in the discussion.
